(19) United States
(12) Patent Application Publication
(10) Pub. No.: US 2026/0006564 A1
(43) Pub. Date: Jan. 1, 2026

(54) BASE STATION, PHASE CONTROL APPARATUS, COMMUNICATION SYSTEM, COMMUNICATION METHOD AND PROGRAM

(71) Applicant: SoftBank Corp., Tokyo (JP)

(72) Inventors: Takuya Hasegawa, Tokyo (JP); Yoshichika Ota, Tokyo (JP); Mitsukuni Konishi, Tokyo (JP); Atsushi Nagate, Tokyo (JP)

(73) Assignee: SoftBank Corp., Tokyo (JP)

(21) Appl. No.: 18/846,439

(22) PCT Filed: Mar. 9, 2023
(86) PCT No.: PCT/JP2023/009115

§ 371 Date: Aug. 5, 2025

(30) Foreign Application Priority Data
Mar. 31, 2022 (JP) 2022-058915

(51) Int. Cl. H04W 52/52; H04B 7/155; H04B 7/185; H04W 16/26

(52) U.S. Cl. CPC H04W 52/52; H04B 7/155; H04B 7/185; H04W 16/26

(57) ABSTRACT

It is provided of a communication system capable of suppressing a fluctuation in a reception power of a known signal from a base station due to an attitude change of a radio relay apparatus, and performing an appropriate gain control of a power amplifier of the radio relay apparatus based on the reception power of the known signal, in case that the base station uses a plurality of linear polarization antennas for wireless communication with the radio relay apparatus. The base station comprises an antenna apparatus that has a plurality of linear polarization antennas capable of transmitting and receiving radio waves with different angles of linear polarization planes from each other when performing a feeder-link communication with the radio relay apparatus, and a base-station processing section or an externally-attached phase control apparatus for controlling a phase difference between plural transmission signals supplied to the plurality of the linear polarization antennas, so that a combined polarization of radio waves of the known signal transmitted from the antenna apparatus to the radio relay apparatus becomes a circular polarization or an elliptical polarization, with respect to a predetermined time slot for transmitting to the radio relay apparatus a specific known signal usable for gain control of a power amplifier of the radio relay apparatus.

### TECHNICAL FIELD

The present invention relates to a base station for wirelessly communicating with a radio relay apparatus, a phase control apparatus, a communication system, a communication method and a program.

### BACKGROUND ART

It is conventionally known a system having a function (for example, an automatic gain control (AGC) function) of controlling a gain of a power amplifier that amplifies a power of a transmission signal transmitted to a terminal apparatus by a radio relay apparatus, based on a reception power of a known signal (for example, a synchronization signal or a reference signal) transmitted from the base station apparatus, considering a loss in a propagation path between an antenna of the radio relay apparatus and an antenna of the base station apparatus, in the radio relay apparatus for relaying radio signals transmitted from the base station apparatus located on the ground or on the sea, etc. Patent Literature 1 discloses an apparatus that measures a power size of a sync signal (synchronization signal) of a reception signal received through an IF/RF receiver of a relay apparatus (radio relay apparatus), calculates an amplifier gain of the relay apparatus to maintain constant a coverage of the relay apparatus based on a measured power size of the sink signal, and controls an amplifier of the relay apparatus with the calculated gain. According to the apparatus in this patent literature, it is said that the coverage of the relay apparatus can be flexibly adjusted.

### CITATION LIST

### Patent Literature

Patent Literature 1: Japanese Unexamined Patent application publication (Translation of PCT Application) No. 2015-500586.

### SUMMARY OF INVENTION

### Technical Problem

In the case that the foregoing radio relay apparatus is positioned in an upper airspace like a floating or flying object such as a HAPS, drone, balloon, etc., even if the loss in the propagation path of the feeder link between the radio relay apparatus and the base station apparatus is constant, the reception power of the known signal used to adjust the gain of the power amplifier fluctuates due to an attitude change such as a rotation or tilt of the radio relay apparatus, it may not be possible to properly control the gain of the power amplifier of the radio relay apparatus. In particular, in the case that an antenna for feeder link uses a plurality of linear polarization antennas (for example, vertical polarization antennas and horizontal polarization antennas) that are advantageous for communicating user data and can reduce an internal loss and reduce size and weight, the fluctuation of the reception power of the known signal is large. Furthermore, there is also the problem that it is difficult to control the gain of the power amplifier based only on the reception power of the known signal.

### Solution to Problem

A communication system according to an aspect of the present invention is a communication system that is provided with a radio relay apparatus and a base station for wirelessly communicating with the radio relay apparatus. In this communication system, the base station comprises an antenna apparatus that has a plurality of linear polarization antennas capable of transmitting and receiving radio waves with different angles of linear polarization planes from each other when performing a feeder-link communication with the radio relay apparatus, and a base-station processing section for controlling a phase difference between a plurality of transmission signals supplied to the plurality of the linear polarization antennas, so that a combined polarization of radio waves of the known signal transmitted from the antenna apparatus to the radio relay apparatus becomes a circular polarization or an elliptical polarization, with respect to a predetermined time slot for transmitting to the radio relay apparatus a specific known signal usable for gain control of a power amplifier of the radio relay apparatus. The radio relay apparatus comprises a power amplifier capable of performing a gain control so that a power of a transmission signal transmitted to a terminal apparatus is set to a predetermined power, based on a reception power of the known signal received from the base station apparatus.

A communication system according to another aspect of the present invention is a communication system that is provided with a radio relay apparatus and a base station for wirelessly communicating with the radio relay apparatus. In this communication system, the base station comprises an antenna apparatus that has a plurality of linear polarization antennas capable of transmitting and receiving radio waves with different angles of linear polarization planes from each other when performing a feeder-link communication with the radio relay apparatus, and an externally-attached phase control apparatus for controlling a phase difference between plural transmission signals supplied to the plurality of the linear polarization antennas, so that a combined polarization of radio waves of the known signal transmitted from the antenna apparatus to the radio relay apparatus becomes a circular polarization or an elliptical polarization, with respect to a predetermined time slot for transmitting to the radio relay apparatus a specific known signal usable for gain control of a power amplifier of the radio relay apparatus. The radio relay apparatus comprises a power amplifier capable of performing a gain control so that a power of a transmission signal transmitted to a terminal apparatus is set to a predetermined power, based on a reception power of the known signal received from the base station apparatus.

Herein, without being limited to the predetermined time slot including a known signal, a fixed phase difference may be given to two base station signals transmitted to two linear polarization antennas.

A base station according to yet another aspect of the present invention is a base station apparatus for wirelessly communicating with a radio relay apparatus. This base station comprises an antenna apparatus that has a plurality of linear polarization antennas capable of transmitting and receiving radio waves with different angles of linear polarization planes from each other when performing a feeder-link communication with the radio relay apparatus, and a base-station processing section for controlling a phase difference between plural transmission signals supplied to the plurality of the linear polarization antennas, so that a combined polarization of radio waves of the known signal transmitted from the antenna apparatus to the radio relay apparatus becomes a circular polarization or an elliptical polarization, with respect to a predetermined time slot for transmitting to the radio relay apparatus a specific known signal usable for gain control of a power amplifier of the radio relay apparatus.

A base station according to yet another aspect of the present invention is a base station apparatus for wirelessly communicating with a radio relay apparatus. This base station comprises an antenna apparatus that has a plurality of linear polarization antennas capable of transmitting and receiving radio waves with different angles of linear polarization planes from each other when performing a feeder-link communication with the radio relay apparatus, and an externally-attached phase control apparatus for controlling a phase difference between plural transmission signals supplied to the plurality of the linear polarization antennas, so that a combined polarization of radio waves of the known signal transmitted from the antenna apparatus to the radio relay apparatus becomes a circular polarization or an elliptical polarization, with respect to a predetermined time slot for transmitting to the radio relay apparatus a specific known signal usable for gain control of a power amplifier of the radio relay apparatus.

An externally-attached phase control apparatus according to yet another aspect of the present invention, which is disposed between a base station apparatus of a base station for wirelessly communicating with a radio relay apparatus and an antenna apparatus having a plurality of linear polarization antennas capable of transmitting and receiving radio waves with different angles of linear polarization planes from each other when performing a feeder-link communication with the radio relay apparatus, and controls a phase difference between plural transmission signals supplied to the plurality of the linear polarization antennas, so that a combined polarization of radio waves of the known signal transmitted from the antenna apparatus to the radio relay apparatus becomes a circular polarization or an elliptical polarization, with respect to a predetermined time slot for transmitting to the radio relay apparatus a specific known signal usable for gain control of a power amplifier of the radio relay apparatus.

A method according to yet another aspect of the present invention is a method for wirelessly communicating between a base station and a radio relay apparatus. This method includes controlling, by the base station, a phase difference between plural transmission signals supplied to the plurality of the linear polarization antennas, so that a combined polarization of radio waves of the known signal transmitted from the antenna apparatus to the radio relay apparatus becomes a circular polarization or an elliptical polarization, via an antenna apparatus that has a plurality of linear polarization antennas capable of transmitting and receiving radio waves with different angles of linear polarization planes from each other when performing a feeder-link communication with the radio relay apparatus, with respect to a predetermined time slot for transmitting to the radio relay apparatus a specific known signal usable for gain control of a power amplifier of the radio relay apparatus, and controlling, by the radio relay apparatus, a gain of a power amplifier so that a power of a transmission signal transmitted to a terminal apparatus is set to a predetermined power, based on a reception power of the known signal received from the base station apparatus.

A program according to yet another aspect of the present invention is a program executed by a computer or processor provided in a base station for wirelessly communicating with a radio relay apparatus. This program includes a program code for controlling a phase difference between plural transmission signals supplied to the plurality of the linear polarization antennas, so that a combined polarization of radio waves of the known signal transmitted from the antenna apparatus to the radio relay apparatus becomes a
circular polarization or an elliptical polarization, via an antenna apparatus that has a plurality of linear polarization antennas capable of transmitting and receiving radio waves with different angles of linear polarization planes from each other when performing a feeder-link communication with the radio relay apparatus, with respect to a predetermined time slot for transmitting to the radio relay apparatus a specific known signal usable for gain control of a power amplifier of the radio relay apparatus.

The foregoing plurality of the linear polarization antennas may be a first linear polarization antenna (for example, a vertical polarization antenna) and a second linear polarization antenna (for example, a horizontal polarization antenna) whose linear polarization planes are orthogonal to each other, and may control, for the predetermined time slot, the phase difference between the plural transmission signals supplied to each of the first linear polarization antenna and the second linear polarization antenna, so as to be 90 degrees or −90 degrees.

The foregoing radio relay apparatus may detect a timing of the known signal received from the base station apparatus by performing a correlation process with a replica of the known signal, measure a reception power of the known signal based on the timing of the known signal, and perform gain control of the power amplifier based on a measurement result of the reception power of the known signal.

The foregoing base station apparatus may be provided in a gateway station. Further, the foregoing radio relay apparatus may be mounted on a floating object or a flying object that is positioned in an upper airspace. For example, the foregoing radio relay apparatus may be mounted on a drone, a balloon, an airship, a HAPS, or an artificial satellite.

### Advantageous Effects of Invention

According to the present invention, in the case that a base station apparatus uses a plurality of linear polarization antennas for radio communication of feeder link with a radio relay apparatus, it is possible to suppress a fluctuation in a reception power of a known signal from the base station apparatus due to a change in an attitude of the radio relay apparatus, and to perform an appropriate gain control of a power amplifier of the radio relay apparatus based on the reception power of the known signal.

### BRIEF DESCRIPTION OF DRAWINGS

FIG. 1 is an illustration showing an example of a main configuration of a communication system including a base station according to an embodiment.

FIG. 2 is an illustration showing an example of an overall configuration of a communication system with a layered cell structure including the base station according to the embodiment.

FIG. 3 is an illustration showing an example of a main configuration of a communication system including the base station and a GW station according to the embodiment.

FIG. 4 is an illustration showing an example of an automatic gain control (AGC) of a radio relay apparatus in the communication system according to the embodiment.

FIG. 5 is an illustration showing a roll, pitch and yaw rotation of a reception antenna.

FIG. 6A is an illustration showing an example of an SS transmission signal.

FIG. 6B is an illustration showing an example of the SS reception signal in the case that there is no rotation of the reception antenna.

FIG. 6C is an illustration showing an example of the SS reception signal in the case that there is a rotation of the reception antenna.

FIG. 7A is an illustration showing an example of a transmission signal of a data CH.

FIG. 7B is an illustration showing an example of a reception signal of the data CH in the case that there is no rotation of the reception antenna.

FIG. 7C is an illustration showing an example of the reception signal of the data CH in the case that there is a rotation of the reception antenna.

FIG. 8A is an illustration showing a relationship between an pointing direction of a FL antenna apparatus and a polarization direction of a transmission antenna of a HAPS base station, and a polarization direction of a reception antenna of the radio relay apparatus.

FIG. 8B is a graph showing a relationship of a relative reception power for a rotation amount of a reception antenna in simulation results in a communication system according to a comparative example.

FIG. 8C is a graph showing a relationship of a relative reception power for a rotation amount of the reception antenna in simulation results in the communication system according to the present embodiment.

FIG. 9 is a block diagram showing an example of a configuration of sections corresponding to a downlink of the HAPS base station and the radio relay apparatus in the communication system according to the embodiment.

FIG. 10 is a block diagram showing another example of a configuration of sections corresponding to the downlink of the HAPS base station and the radio relay apparatus in the communication system according to the embodiment.

FIG. 11 is an illustration showing an example of a synchronization method for detecting a frame timing using a synchronization signal and a reception power of the synchronization signal in the radio relay apparatus according to the embodiment.

### DESCRIPTION OF EMBODIMENTS

Hereinafter, embodiments of the present invention are described with reference to the drawings. Herein, although embodiments of the present invention are described on the premise of application to the 3GPP LTE/LTE-Advanced mobile communication system and the next-generation NR (New Radio) mobile communication system after the 5th generation, the concept of the present invention is applicable to any system that uses similar cell configurations and physical channel configurations.

A communication system according to the embodiment described herein is provided with a radio relay apparatus (non-regenerative relay station) that is an upper airspace platform installed in a High Altitude Platform Station (HAPS) (also referred to as “High Altitude Pseudo satellite”), drone, airship, balloon, etc. and positioned in an upper airspace, and a base station (hereinafter referred to as “HAPS base station”) positioned on the ground or on the sea. While using a plurality of linear polarization antennas (for example, vertical polarization antennas and horizontal polarization antennas) in both the radio relay apparatus and the HAPS base station, a radio wave of a known signal (for example, synchronization signal or reference signal) transmitted from the HAPS base station to the radio relay apparatus in the upper airspace is circularly polarized. Thereby, without using a circular polarization antenna that has a large internal loss of reception signal and a large additional weight and size, it is possible to suppress fluctuations in a reception power of the known signal from the HAPS base station due to an attitude change (for example, rotation) of the radio relay apparatus, and appropriately control a gain of a power amplifier that amplifies a transmission signal of a service link transmitted from the radio relay apparatus to the terminal apparatus (UE), based on the reception power of only the known signal.

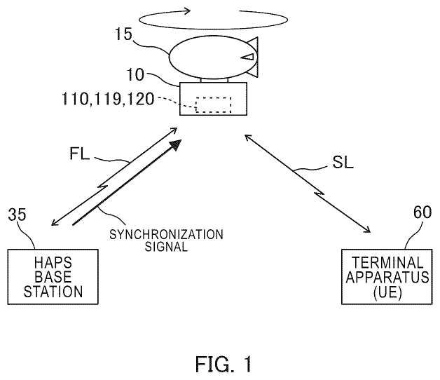

FIG. 1 is an illustration showing an example of a main configuration of a communication system (radio relay system) including a radio relay apparatus 10 according to the present embodiment. In FIG. 1, the communication system is provided with an upper-airspace staying type radio relay apparatus 10 installed on a flying object flying in an upper airspace (for example, HAPS, airship, solar plane, drone, balloon, etc.) 15 or the like. The radio relay apparatus 10 is a repeater-type relay station (non-regenerative relay station), and the radio relay apparatus 10 performs a wireless communication with a HAPS base station 35 on the ground via a feeder link FL, performs a wireless communication with a terminal apparatus (UE) 60 via a service link SL, and relays a communication between the HAPS base station 35 and the terminal apparatus (UE) 60. The radio relay apparatus 10 includes a power amplifier (PA) 110 as a first-power amplification section that amplifies the transmission signal of the service link SL, a power amplifier (PA) 119 as a middle-stage power amplification section that performs the AGC, and a power amplifier (PA) 120 as a second-power amplification section that amplifies the transmission signal of the feeder link FL. It is noted that the communication system (radio relay system) may include the HAPS base station 35 in addition to the radio relay apparatus 10, and may further include the UE 60.

The power amplifier 119 as the middle-stage power amplification section has an automatic gain control (AGC) function to control the gain so that the power of the transmission signal of the service link SL to the terminal apparatus (UE) 60 is constant, based on a measurement result of a reception power of a specific known signal (for example, a synchronization signal: SS) received from the HAPS base station 35.

A frequency (frequency band) of the feeder link FL and a frequency (frequency band) of the service link SL may be different frequencies (frequency bands) from each other in order to prevent an interference caused by wraparound of radio waves.

The radio relay apparatus 10 is provided with a function of detecting a synchronization signal included in a high frequency radio (RF) signal of the downlink received from the HAPS base station 35 via the feeder link FL, and the radio relay apparatus 10 is capable of detecting a frame timing of a signal of the downlink to be relayed (hereinafter also referred to as a “downlink signal”). Further, the radio relay apparatus 10 receives base-station information (for example, base-station parameters such as system bandwidth, physical cell ID, subcarrier spacing, etc., quasi-static scheduling information of the downlink including radio-resource allocation positions on a time/frequency grid of the synchronization signal, or quasi-static scheduling information of the downlink and the uplink, and a predetermined offset amount used for calculating the reception power of the synchronization signal) from the HAPS base station 35 or a central control server.

The quasi-static scheduling information is information capable of specifying whether or not each slot includes data to be transmitted for plural slots constituting a radio frame, and information on a downlink-transmission stop pattern for stopping transmission signals in the plural slots. This quasi-static scheduling information may be normal scheduling information that specifies whether or not each symbol contains data (symbols to be transmitted or symbols not to be transmitted) for plural symbols allocated to plural resource elements constituting the radio frame. The foregoing quasi-static scheduling information may not be information that changes for each radio frame, but may be changed regularly or irregularly using plural radio frames as one unit.

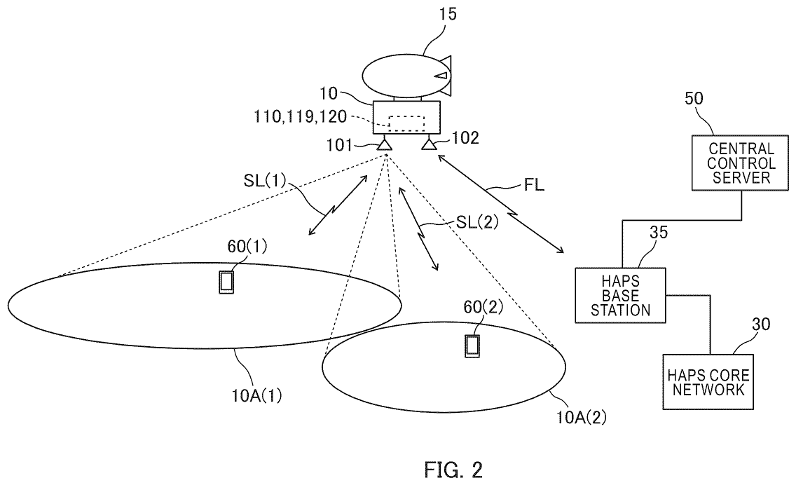

FIG. 2 is an illustration showing an example of an overall configuration of a HAPS-mobile communication system including the radio relay apparatus according to the present embodiment. In FIG. 2, as a countermeasure for communication traffic caused by a disaster response or extraordinary events, etc., wide-area large cells 10A(1) and 10A(2) of plural service links SL(1) and SL(2) of a mobile communication network are formed toward on the ground or on the water (for example, on the sea) from the antenna 102 of the flying object 15 such as an airship, a solar plane, a drone, a balloon, etc. as a movable floating object positioned in the upper airspace. The plural large cells 10A(1) and 10A(2) are formed by a single radio relay apparatus, which are also referred to as “sector cells.”

In the example of FIG. 2, although an example is shown in which the flying object 15 having the radio relay apparatus 10 is an airship type HAPS (“High altitude platform station” or “high altitude pseudo satellite”) that is capable of moving in the upper airspace, the flying object 15 may be another unmanned or manned flying object such as a drone, a balloon, an aircraft, a helicopter, a solar-plane type HAPS or LAPS (“low altitude platform station” or “low altitude pseudo satellite”), an airship type LAPS, an artificial satellite, etc., which are capable of moving or flying in the upper airspace. After the flying object 15 moves to a predetermined position in the upper airspace positioned when operating to perform a radio relay, it may be controlled to stay at that position or to fly circularly within a predetermined range of flight space that includes that position.

The flying object may be controlled so as to fly and position in an airspace with an altitude of 100 [km] or less from the ground level, the sea level, or the water level such as a river or lake, by autonomous control or external control or by the operation of a pilot aboard the flying object. A flight airspace of the flying object may be a stratospheric airspace with an altitude of 11 [km] or more and 50 [km] or less. Furthermore, the flight airspace of the flying object may be an airspace with an altitude of 15 [km] or more and 25 [km] or less where weather conditions are relatively stable, and may be an airspace with an altitude of approximately 20 [km] in particular.

The mobile communication system of the present embodiment is a communication system compliant with the next-generation standard specifications such as the LTE (Long Term Evolution)/LTE-Advanced or the 5th generation, and the radio relay apparatus 10 has an antenna for service links SL(1) and SL(2) (hereinafter also referred to as “SL antenna apparatus”) 101 for forming a plurality of large cells 10A(1) and 10A(2), and an antenna for feeder a link FL (hereinafter also referred to as “FL antenna apparatus”) 102 for wirelessly communicating with a HAPS base station (for example, eNodeB, gNodeB) 35 provided on the ground side. The HAPS base station 35 is connected to a HAPS core network 30 of the mobile communication network via a communication line such as a line termination apparatus and a dedicated line, etc., and is capable of communicating with various kinds of nodes such as core network apparatuses and servers, etc. by using a predetermined communication interface.

Each of the SL antenna apparatus 101 and the FL antenna apparatus 102 of the radio relay apparatus 10 has a vertical polarization antenna and a horizontal polarization antenna as a plurality of linear polarization antennas. The vertical polarization antenna transmits and receives a radio wave with a vertical polarization plane including a vertical direction and a radio-wave propagation direction. The horizontal polarization antenna transmits and receives a radio wave with a horizontal polarization plane that is perpendicular to the vertical polarization plane and includes the radio-wave propagation direction. Each of the SL antenna apparatus 101 and the FL antenna apparatus 102 may be an array antenna, in which antenna elements configured with the vertical polarization antenna and the horizontal polarization antenna as a pair are disposed one-dimensionally, two-dimensionally or three-dimensionally.

It is noted that the HAPS core network 30 may be a common core network that accommodates the HAPS base stations 35 of the large cells 10A(1) and 10A(2). Further, the frequency used in the cells 10A(1) and 10A(2) may be, for example, a microwave band frequency of 300 MHz to 30 GHz, or a millimeter wave band frequency higher than 30 GHz.

In the present embodiment, the radio relay apparatus 10 mounted on the flying object 15 is capable of communicating with the HAPS core network 30 of the mobile communication network, various kinds of core network apparatuses, external networks such as the Internet, various kinds of servers such as a central control server 50, etc., via the antenna 102 and the HAPS base station 35 connected to a gateway (GW) station that is a relay apparatus for the feeder link on the ground side.

The central control server 50 is capable of centrally managing the base-station information such as scheduling information of the HAPS base station 35, etc., and generating control information for controlling the base station. Further, the central control server 50 has a function of managing the base-station information used for the AGC of the middle-stage power amplifier 119 of the radio relay apparatus 10 and notifying the radio relay apparatus 10 of the base-station information. It is noted that the central control server 50 may be installed in a remote location such as a data center, etc., or may be installed in the HAPS core network 30.

When each of the UEs 60(1) and 60(2) is located in the large cells 10A(1) and 10A(2), it is capable of wirelessly communicating with the HAPS base station 35 using a predetermined communication method and radio communication resources via the radio relay apparatus 10 in the upper airspace which corresponds to the cell in which the UEs are located. Each of the UEs 60(1) and 60(2) is configured using hardware such as, for example, a computer apparatus having a CPU, memory, etc., and a radio communication section, etc., and is capable of communicating with the HAPS base station 35 via the radio relay apparatus 10 by executing a predetermined program.

The base station apparatus of the HAPS base station 35 and an externally-attached phase control apparatus described below are configured using hardware such as, for example, a computer apparatus having a CPU, memory, etc., an external-communication interface section for the HAPS core network 30, an external-communication interface section for the central control server 50, a radio communication section and the like, and the base station apparatus and the phase control apparatus are capable of wirelessly communicating with the UEs 60(1) and 60(2) using a predetermined communication method and radio communication resources, transmitting and receiving information to and from the core network apparatus of the HAPS core network 30, and transmitting and receiving information to and from the central control server 50, by executing a predetermined program.

The radio relay apparatus 10 is configured using hardware such as, for example, a computer apparatus having a CPU, memory, etc., radio communication sections for service link and feeder link, and the like, and is capable of wirelessly communicating with the UEs 60(1) and 60(2) using a predetermined communication method and radio communication resources, and transmitting and receiving information to and from the central control server 50 via the HAPS base station 35, by executing a predetermined program.

The radio relay apparatus 10 is capable of performing a process of detecting a frame timing of a radio frame, based on a synchronization signal included in a radio signal received from the HAPS base station 35, and performing the AGC of the middle-stage power amplifier 119, based on base station information received from the HAPS base station 35 or the central control server 50, by executing a predetermined program.

The radio relay apparatus 10 is capable of controlling the gain so that the power of the transmission signal of the service link SL to the terminal apparatus (UE) 60 is constant, based on a measurement result of a reception power of a known signal (for example, a synchronization signal: SS) included in the radio signal received from the HAPS base station 35, by executing a predetermined program.

The HAPS base station 35 is a base station capable of performing a downlink wireless communication using an OFDM (Orthogonal Frequency Division Multiplexing) method for the UE via the radio relay apparatus 10 in the upper airspace. The HAPS base station 35 is provided with, for example, an antenna, a radio-signal path switching section, a duplexer (DUP), an OFDM (Orthogonal Frequency Division Multiplexing) modulation section as a downlink-radio reception section and a downlink modulation section, a control section, an uplink-radio reception section and an uplink demodulation section (for example, SC-FDMA (Single-Carrier Frequency-Division Multiple Access) demodulation section or OFDM demodulation section), etc. Additionally, the HAPS base station 35 may be provided with a downlink-radio transmission section and an OFDM demodulation section for special applications such as a radio interface-based synchronization, etc.

The SC-FDMA demodulation section performs a demodulation processing of the SC-FDMA method for the reception signal received by the uplink-radio reception section, and passes the demodulated data to the control section. The OFDM demodulation section performs a demodulation processing of the OFDM method for the reception signal received by the uplink-radio reception section, and passes the demodulated data to the control section. The OFDM modulation section modulates data of the downlink signal, which is received from the control section to be transmitted to the UE located in the own cell, using the OFDM method so that the data is transmitted with a predetermined power. Further, in the case that the base station receives from the server, for example, information of slot to be stopped for transmission, the OFDM modulation section is controlled to stop a downlink transmission only for the specific slot in the radio frame. The downlink-radio transmission section transmits the transmission signal modulated by the OFDM modulation section to the radio relay apparatus 10 in the upper airspace via the duplexer, the radio-signal path switching section and the antenna.

In the present embodiment, the FL antenna apparatus of the HAPS base station 35 that wirelessly communicates with the radio relay apparatus 10 in the upper airspace via the feeder link FL has a vertical polarization antenna and a horizontal polarization antenna as a plurality of linear polarization antennas. The vertical polarization antenna transmits and receives a radio wave with a vertical polarization plane including the vertical direction and the radio-wave propagation direction (antenna pointing direction). The horizontal polarization antenna transmits and receives a radio wave with a horizontal polarization plane that is perpendicular to the vertical polarization plane and includes the radio-wave propagation direction (antenna pointing direction). The FL antenna apparatus of the HAPS base station 35 may be an array antenna, in which antenna elements configured with the vertical polarization antenna and the horizontal polarization antenna as a pair are disposed one-dimensionally, two-dimensionally or three-dimensionally.

The SL antenna apparatus of the HAPS base station 35 that wirelessly communicates with terminal apparatuses (UE) 60(1) and 60(2) via the service link SL has a vertical polarization antenna and a horizontal polarization antenna as a plurality of linear polarization antennas. The FL antenna apparatus of the HAPS base station 35 may be an array antenna, in which antenna elements configured with the vertical polarization antenna and the horizontal polarization antenna as a pair are disposed one-dimensionally, two-dimensionally or three-dimensionally.

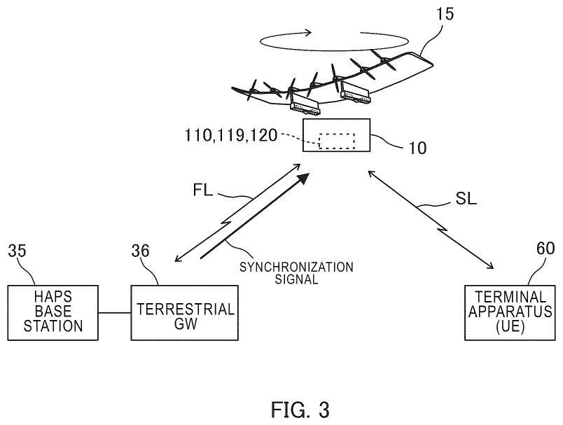

In the communication system of the present embodiment, as shown in FIG. 3, the HAPS base station 35 may be installed in a gateway station (GW station) (hereinafter also referred to as “terrestrial GW”) 36 on the ground as a radio communication section (relay station) disposed on the ground or on the sea, and may be configured to communicate with the radio relay apparatus 10 in the upper airspace via the terrestrial GW 36.

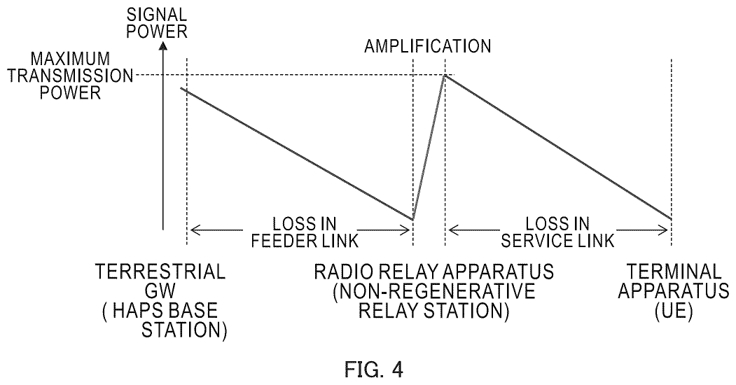

In the mobile system with the aforementioned configuration, as shown in FIG. 4, even if the signal is transmitted from the HAPS base station 35 at maximum transmission power, the signal power when being received by the radio relay apparatus 10 becomes smaller due to the loss in the radio propagation path of the feeder link FL. Therefore, the power of the signal is amplified to a predetermined power by the middle-stage power amplifier 119 on the service link side of the radio relay apparatus 10 and then the signal is transmitted to the terminal apparatus (UE) 60. By controlling so as to determine the gain amount of the middle-stage power amplifier 119 based on the measurement result of the reception power of the known signal (for example, synchronization signal: SS) received from the HAPS base station 35, even if the reception power of the feeder link FL of the radio relay apparatus 10 fluctuates, the power of the transmission signal of the service link SL can be kept constant.

In the radio relay method of the present embodiment, the transmission signal from the HAPS base station 35 is non-regeneratively relayed by the radio relay apparatus (relay station) 10 mounted on the flying object (or floating object) 15 such as a HAPS, etc., via the feeder link FL, and can be directly received by the terminal apparatus (UE) 60 that is widely used in terrestrial mobile-communication systems. When receiving the signal, since the received power of the feeder link signal changes with the flight of the body of the flying object 15, the radio relay apparatus (relay station) 10 in the upper airspace amplifies the signal power by the AGC in order to transmit the signal to the service link SL with maximum power. However, in the mobile communication systems such as 5GNR, etc., from the viewpoint of low power consumption and inter-cell interference suppression, in the case that there is no data signal, unnecessary signals are not transmitted, except for some synchronization signals (SS), etc. which are always transmitted at predetermined timings. Therefore, there may be no signal state for several milliseconds to several tens of milliseconds. In this no-signal section, noise power, loop interference, etc. actually exist, so although it is not completely no input, an unnecessarily large amount of gain is set in the AGC. As one of the control methods for the AGC section to solve this problem, there is a method of observing a reception power of a specific known signal such as a synchronization signal (SS), etc. and determining a gain amount used for the amplification. For example, in the 5GNR radio relay system, by performing a correlation detection process using a replica signal of the synchronization signal (SS) in the AGC section, the signal power of only the synchronization signal (SS) is calculated, and the gain amount is determined without depending on the presence or absence of the data signal.

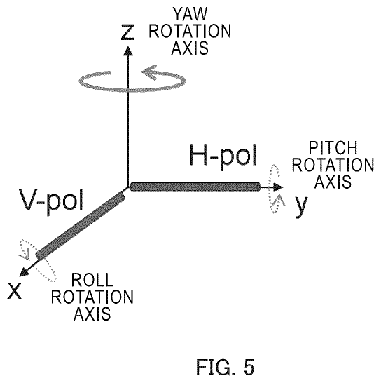

However, in the radio relay apparatus (relay station) 10 in the upper airspace, it is necessary to consider the rotation of the antenna due to the turning flight of the aircraft. In the case of using a horizontal/vertical shared linear polarization antenna as the FL antenna apparatus, when a transmission-antenna pointing direction is set as a rotation axis and a rotation amount (for example, a rotation amount of yaw rotation around the z-axis in FIG. 5) of the reception antenna of the radio relay apparatus (relay station) 10 in the upper airspace is changed, the reception signal of the feeder link FL can be expressed by the following equation (1).

$$[ \begin{matrix}{r}_{0} \\ {r}_{1}\end{matrix} ] = {G}_{RX} \cdot [ \begin{matrix}cos θ & sin θ \\ - sin θ & cos θ\end{matrix} ] \cdot H \cdot {G}_{TX} [ \begin{matrix}{s}_{0} \\ {s}_{1}\end{matrix} ] \qquad ( 1 )$$

Herein, each of r₀, r₁ and s₀, s₁ represents a reception signal and transmission signal at an antennas 0 (vertical polarization) and an antennas 1 (horizontal polarization), each of G_{TX} and G_{RX} represents a gain of the transmission antenna and reception antenna, H represents a channel response, and 0 represents a rotation amount of the reception antenna of the radio relay apparatus (relay station) 10 in the upper airspace when a transmission-antenna pointing direction is set to as a rotation axis. In the case of 2×2 MIMO, although the same signals are transmitted from both antennas as the synchronization signals (SS), antenna weights thereof are not defined. For this reason, for example, in the case of transmitting with equal weight (in phase) from both antennas, the reception powers of the synchronization signals (SS) of r₀ and r₁ may change significantly depending on the value of 0.

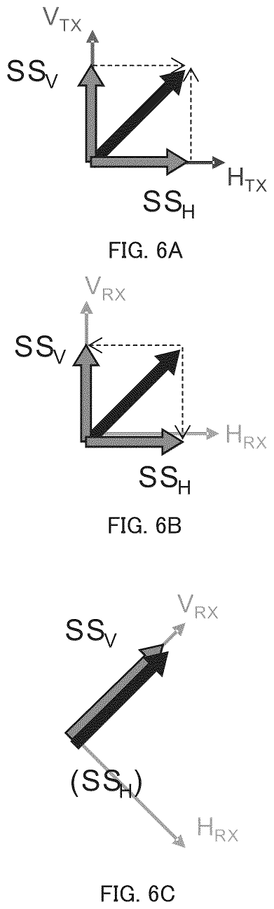

For example, FIG. 6A shows a case where each of the signals SS_{V} and SS_{H} of the two SSs (synchronization signals) with the same power and the same phase are transmitted from the vertical polarization antenna and the horizontal polarization antenna. The combined polarization of the radio waves of the signals transmitted from both antennas becomes a linear polarization tilted at 45 degrees. In this case, as shown in FIG. 6B, although SS_{V} and SS_{H} are received with equal power by both antennas if there is no tilt between the transmission antenna and the reception antenna, SS_{V} and SS_{H} are received by both antennas with unequal power if there is a tilt between the transmission antenna and the reception antenna. When the tilt angle between both antennas is 45 degrees as shown in FIG. 6C, the power of the signal SS_{H} received by the horizontal polarization antenna is significantly reduced.

On the other hand, since the data signal is uncorrelated between the vertical polarization antenna and the horizontal polarization antenna, the reception power at each of the antennas is constant without depending on the rotation amount θ. That is, as the antenna rotates, in each of the reception antennas, a gain error occurs with respect to the maximum signal power to be determined by the AGC.

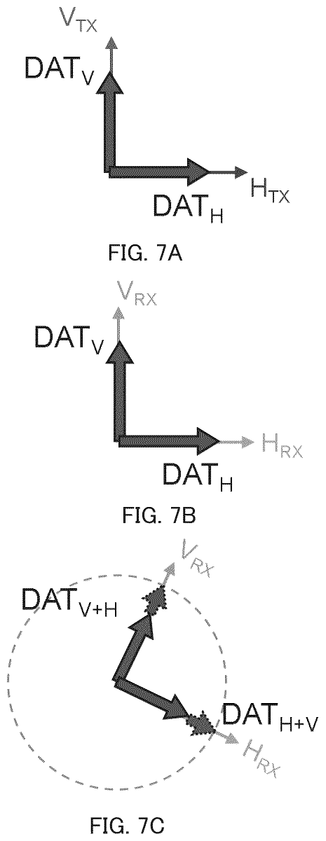

For example, FIG. 7A shows a case where two data CH signals DAT_{V} and DAT_{H} uncorrelated with each other are transmitted from each of the vertical polarization antenna and the horizontal polarization antenna. In this case, if there is no tilt between the transmission antenna and the reception antenna as shown in FIG. 7B, DAT_{V} and DAT_{H} are received by both antennas with equal power to each other. Further, in the case that there is a tilt between the transmission antenna and the reception antenna as shown in FIG. 7C, the desired signal and interference components are combined in the signals received by both antennas, and the power of the reception signal is equal to the case where there is no tilt between the transmission antenna and the reception antenna.

In the case that the AGC is performed based on the reception power of the SS (synchronization signal) received by each of the vertical polarization antenna and the horizontal polarization antenna of the radio relay apparatus 10 described above, there is a problem in that an appropriate AGC cannot be performed caused by the change of the reception power of the SS (synchronization signal) accompanied with the rotation of the antenna. Although such problems can generally be solved by using a circular polarization antenna shared with right rotation and left rotation, for this purpose, the FL antenna apparatus of the radio relay apparatus (relay station) 10 side in the upper airspace also needs be the circular polarization antenna, and this may result in larger internal loss and larger weight and size than when using the linear polarization antenna.

Therefore, in the present embodiment, assuming that the linear polarization antenna is used as the FL antenna apparatus of the HAPS base station 35, by giving a predetermined phase difference (for example, a phase difference of 90 degrees or −90 degrees) to the transmission signal of the synchronization signal (SS) transmitted from each linear polarization antenna (vertical polarization antenna and vertical polarization antenna) of the HAPS base station 35, the circular polarization or the elliptical polarization is equivalently formed as the combined polarization for the transmission signal of the synchronization signal (SS), and the gain error is eliminated or reduced.

It is noted that the phase difference between the synchronization signals (SS) transmitted respectively from the linear polarization antennas (vertical polarization antenna and vertical polarization antenna) may be such that the synchronization signals (SS) can equivalently form a circular polarization (or an elliptical polarization) so as to eliminate the gain error, and may be, for example, a phase difference of 85 degrees to 95 degrees or −85 degrees to −95 degrees, a phase difference of 88 degrees to 92 degrees or −88 degrees to −92 degrees, or a phase difference of 89 degrees to 91 degrees or −89 degrees to −91 degrees, in addition to the phase difference of 90 degrees or −90 degrees.

Next, results of computer simulation evaluation performed on an influence of uniaxial antenna rotation around the pointing direction of the FL antenna apparatus of the HAPS base station 35 and an effect of phase control in the communication system of the present embodiment are described.

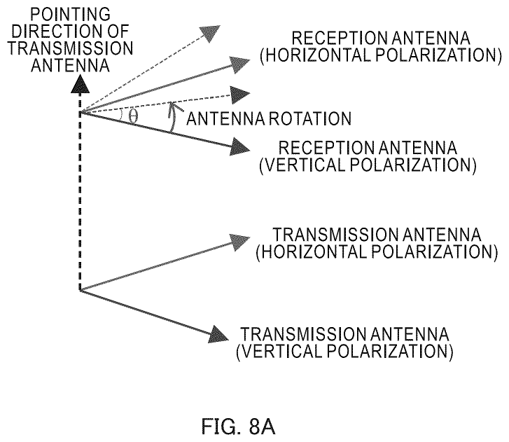

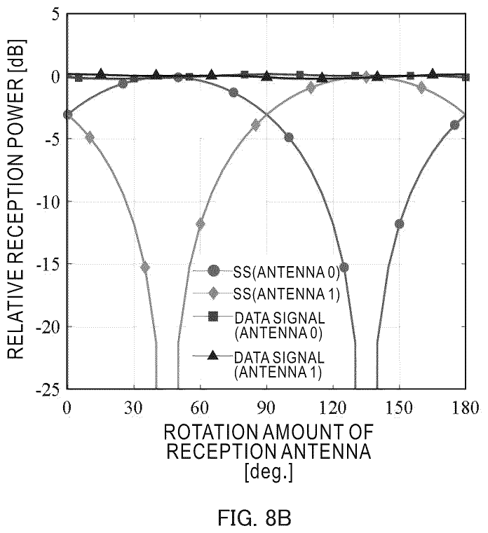

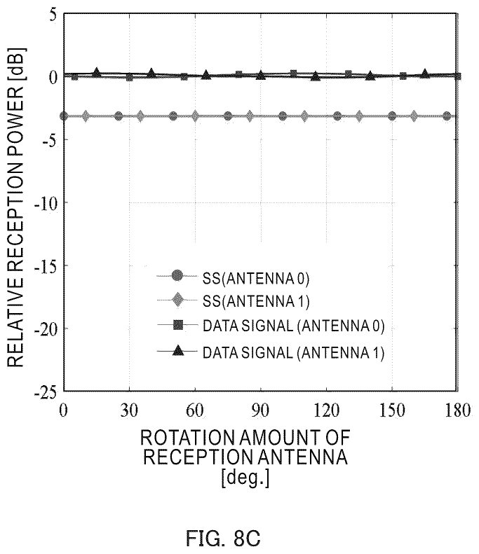

FIG. 8A is an illustration showing a relationship between the pointing direction of the FL antenna apparatus of the HAPS base station 35, the polarization directions (vertical polarization, horizontal polarization) of two transmission antennas consisting of linear polarization antennas, and the polarization directions (vertical polarization, horizontal polarization) of the two reception antennas consisting of linear polarization antennas of the radio relay apparatus 10. FIG. 8B is a graph showing a relationship of a relative reception power for a rotation amount of a reception antenna in a simulation result in a communication system according to a comparative example in which the phase control of the synchronization signal is not performed on the HAPS base station 35 side. FIG. 8C is a graph showing a relationship of a relative reception power for a rotation amount of a reception antenna in a simulation result in the communication system according to the present embodiment in which the phase control of the synchronization signal is performed on the HAPS base station 35 side.

In the present simulation, assuming a 5GNR OFDM (Orthogonal Frequency Division Multiplexing) signal, with respect to transmission signals s0 and s1, SSs (synchronization signals) with the same power and phase between the two transmission antennas and QPSK (Quadrature Phase Shift Keying) data signals uncorrelated between the two transmission antennas are transmitted respectively. Each of the numbers of subcarriers used for the data signals and the SSs (synchronization signals) is set to 300 and 127 to correspond to the system bandwidth of 5 MHz in the 5G NR (assuming an FDD band of 2 GHz or less in the service link). In order to purely evaluate the influence of the rotation of the reception antenna, the gain G_{TX} of the transmission antenna, the gain G_{RX} and H (channel response) of the reception antenna are set as unit matrices (assuming perfect line-of-sight and free-space propagation loss, the cross-polarization discrimination of the antenna is assumed to be ideal), and the influence of the rotation is evaluated by relative reception power from the maximum reception power. Results in the cases that the phase difference between the two SSs (synchronization signals) supplied to the two transmission antennas is in phase (comparative example) and 90 degrees (present embodiment) are shown in FIGS. 8B and 8C, respectively.

In the case of the comparative example of FIG. 8B, when the rotation amount θ of the reception antenna apparatus with respect to the transmission antenna apparatus is 0 degree, the polarization plane of each antenna is the same on the transmission and reception sides, so the relationships between the reception signals r₀, r₁ and the transmission signals s₀, s₁ are r₀=s₀ and r₁=s₁. In this case, although there is a certain difference (approximately 3 dB) between the reception power of the SS (synchronization signal) and the reception power of the data signal, this difference in the reception power is due to the difference in the number of subcarriers used, and the AGC may be performed by regarding this difference as a fixed offset. And then, as the rotation amount θ of the reception antenna with respect to the transmission antenna increases, the SS (synchronization signal) reception power of r₀ increases, while the SS (synchronization signal) reception power of r₁ decreases. Since the same in-phase SS (synchronization signal) is transmitted on the transmission antenna side, it is equivalent to combining the vertical polarization and the horizontal polarization, and it can be assumed that the linearly polarized SS (synchronization signal) rotated by 45 degrees is transmitted. Therefore, when the rotation amount θ is around 45 degrees, the SS (synchronization signal) reception power of r₀ increases by 3 dB with respect to the transmission power, and the SS (synchronization signal) reception power of r₁ is extremely reduced.

When the rotation amount θ of the reception antenna with respect to the transmission antenna is 90 degrees, since the polarization planes of the vertical polarization antenna on the transmission side and the horizontal polarization antenna on the reception side are aligned with each other, r₀=s₁ and r₁=s₀, and as same as when θ is 0 degrees, the reception powers of the SS (synchronization signal) and the data signal match each other by considering the fixed offset, therefore, an appropriate gain control can be performed by the AGC. When θ is greater than 90 degrees, the similar characteristics can be obtained by reversing the relationship between the two linear polarization antennas. On the other hand, since the data signal is uncorrelated between the two linear polarization antennas, the reception power is constant without depending on θ.

In the simulation of the present embodiment shown in FIG. 8C, since the SS (synchronization signal) transmitted from the transmission antenna apparatus configured with two linear polarization antennas is a circular polarization, the reception powers of both the SS (synchronization signal) and the data signal are always constant without depending on θ. Therefore, even if the reception antenna apparatus is rotated with respect to the transmission antenna apparatus, the radio relay apparatus (non-regenerative relay station) 10 is capable of receiving the SS (synchronization signal) with constant power and appropriately controlling the gain amount of the power amplifier.

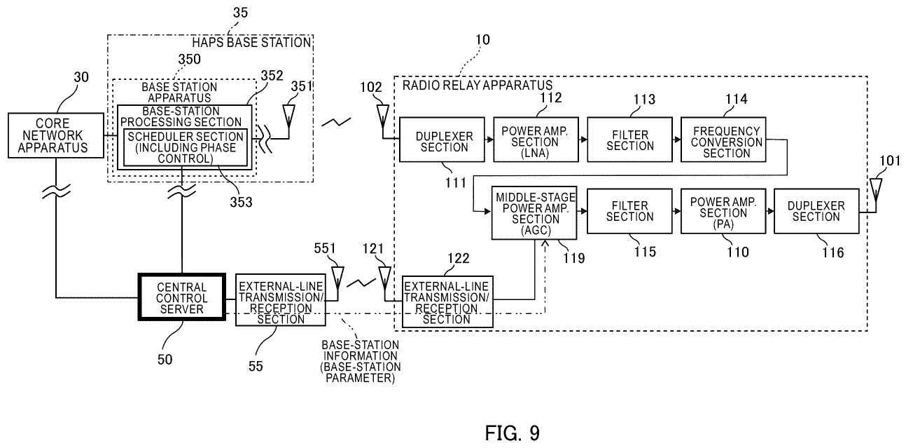

FIG. 9 is a block diagram showing a configuration example of sections corresponding to the downlink of the HAPS base station 35 and the radio relay apparatus 10 in the communication system according to the embodiment.

In FIG. 9, the radio relay apparatus 10 is provided with the SL antenna apparatus 101 for service link configured with the vertical polarization antenna and the horizontal polarization antenna, the antenna apparatus 102 for feeder link configured with the vertical polarization antenna and the horizontal polarization antenna, a duplexer section 111 on the feeder link side, a power amplifier (LNA) 112 for the feeder-link reception signal, a filter section 113 for the feeder-link reception signal, a frequency conversion section 114 for performing a frequency conversion process between the frequency of the feeder link FL and the frequency of the service link SL, a filter section 115 for the service-link transmission signal, a power amplifier (PA) 110 configured with an FET (field effect transistor) or the like that amplifies the service-link transmission signal, a duplexer section 116 on the service link side, and a middle-stage power amplifier section (power amplifier) 119.

The middle-stage power amplification section (power amplifier) 119 performs a correlation process for the received relay signal, and detects the frame timing of the downlink (for example, time information on the beginning of the radio frame, or time information on the beginning of a slot with a predetermined number that includes the synchronization signal), and the reception power of the synchronization signal, based on the synchronization signal included in the received relay signal.

The middle-stage power amplification section (power amplifier) 119 also has a function as means for controlling the gain of the middle-stage power amplification section (power amplifier) 119 so that the power of the transmission signal transmitted to the terminal apparatus (UE) is set to a predetermined power, based on the reception power of the synchronization signal (SS) received from the HAPS base station 35.

In FIG. 9, the base-station information is delivered from the central control server 50 to a base-station processing section 352 provided in a base station apparatus 350 of the HAPS base station 35. The base-station processing section 352 of the HAPS base station 35 has, for example, a baseband processing section and a radio communication section, and the base-station processing section 352 uses a scheduler section 353 to generate a relay signal in a predetermined radio frame based on the data to be transmitted, by using a clock signal of an internal clock 154 as a reference, and transmits the relay signal to the radio relay apparatus 10 via the FL antenna apparatus 351 configured with the vertical polarization antenna (first linear polarization antenna) and the horizontal polarization antenna (second linear polarization antenna). The synchronization signal (SS) is disposed in the radio frame of the relay signal.

With respect to a predetermined time slot in which an SS (synchronization signal) as a specific known signal that can be used for gain control of the middle-stage power amplification section (power amplifier) 119 of the radio relay apparatus 10 is transmitted to the radio relay apparatus 10, the base-station processing section 352 controls the phase difference between the plural transmission signals (relay signals) supplied to the plurality of the linear polarization antennas (vertical polarization antenna, horizontal polarization antenna) of the FL antenna apparatus 351 so that the combined polarization of the SS (synchronization signal) radio waves transmitted from the FL antenna apparatus 351 to the radio relay apparatus 10 becomes a circular polarization or an elliptical polarization. For example, with respect to the predetermined time slot in which the SS (synchronization signal) is disposed, the base-station processing section 352 controls the phase difference between the plural transmission signals (relay signals) supplied to the plurality of the linear polarization antennas (vertical polarization antenna, horizontal polarization antenna) of the FL antenna apparatus 351 to be 90 degrees or −90 degrees.

In FIG. 9, the central control server 50 may transmit to the radio relay apparatus 10 from an external-line transmission and reception section (for example, a satellite communication module, a WiFi module, or another mobile communication module) 55 and an antenna 551 via a communication line (for example, a satellite communication line, a WiFi line, another mobile communication line, etc.) different from the feeder link of the relay signal. The middle-stage power amplification section (power amplifier) 119 of the radio relay apparatus 10 acquires the base-station information (base-station parameters) from the central control server 50, which is received by the antenna 121 and external-line transmission and reception section (for example, a satellite communication module, a WiFi module, another mobile communication module) 122, via a communication line (a satellite communication line, a WiFi line, another mobile communication line, etc.) different from the feeder link of the relay signal.

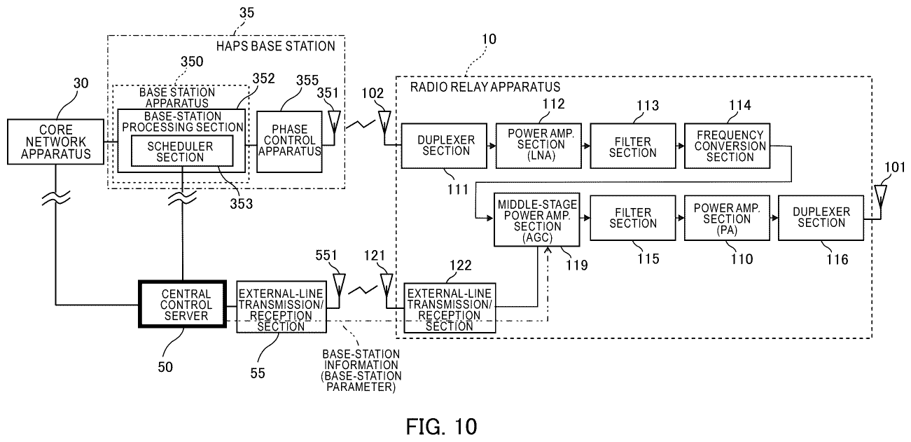

FIG. 10 is a block diagram showing another configuration example of sections corresponding to the downlink of the HAPS base station 35 and the radio relay apparatus 10 in the communication system according to the embodiment. It is noted that in FIG. 10, parts similar to those in the configuration of FIG. 9 described above are designated by the same reference numerals, and description thereof is omitted.

In the configuration example of FIG. 10, the above-mentioned phase control is performed not by the base-station processing section 352 but by an externally-attached phase control apparatus 355. With respect to the predetermined time slot in which the SS (synchronization signal) as the specific known signal that can be used for gain control of the middle-stage power amplification section (power amplifier) 119 of the radio relay apparatus 10 is transmitted to the radio relay apparatus 10, the phase control apparatus 355 controls the phase difference between the plural transmission signals (relay signals) supplied to the plurality of the linear polarization antennas (vertical polarization antenna, horizontal polarization antenna) of the FL antenna apparatus 351 so that the combined polarization of the SS (synchronization signal) radio waves transmitted from the FL antenna apparatus 351 to the radio relay apparatus 10 becomes a circular polarization or an elliptical polarization. For example, with respect to the predetermined time slot in which the SS (synchronization signal) is disposed, the phase control apparatus 355 controls the phase difference between the plural transmission signals (relay signals) supplied to the plurality of the linear polarization antennas (vertical polarization antenna, horizontal polarization antenna) of the FL antenna apparatus 351 to be 90 degrees or −90 degrees.

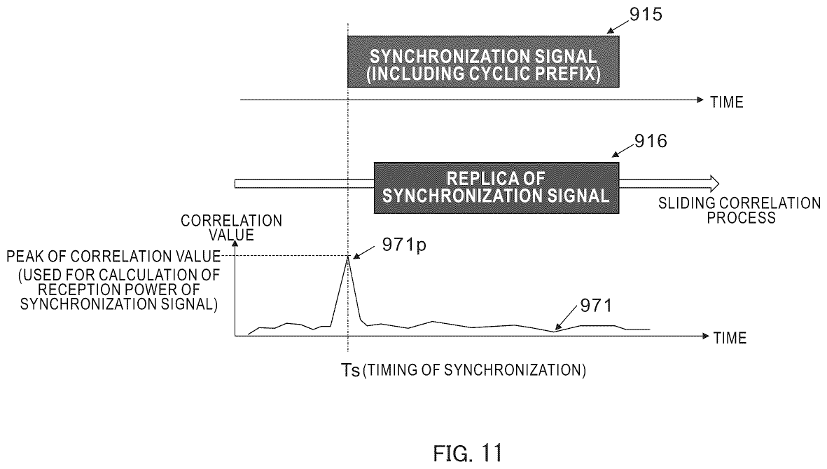

FIG. 11 is an illustration showing an example of a synchronization method for detecting a frame timing using a synchronization signal (SS) and a reception power of the synchronization signal in the radio relay apparatus 10 according to the present embodiment. The radio relay apparatus 10 uses a method of detecting a synchronization signal (SS) included in an RF signal (radio signal) that is a downlink relay signal received from the HAPS base station 35 in order to detect a frame timing. The radio relay apparatus 10 is provided with an RF-signal reception mechanism (a radio interface-based synchronization apparatus), and can hold arbitrary RF-signal waveform data. The radio relay apparatus 10 holds a replica of a synchronization signal that is a known signal expected to be transmitted from the HAPS base station 35, and performs a time correlation process for the received RF signal using the replica signal to detect the peak position of the correlation value and specify the frame timing.

In FIG. 11, the radio relay apparatus 10 receives the synchronization signal of the HAPS base station 35 and performs a sliding correlation process on the time axis. In FIG. 11, the radio relay apparatus 10 receives a synchronization signal 915 from the HAPS base station 35 at a predetermined timing. The radio relay apparatus 10 also generates a replica sequence 916 of the synchronization signal. While sliding this replica sequence 916, a correlation value 971 between a reception signal of the synchronization signal 915 and the combined replica sequence 916 is calculated, and a peak 971p of the correlation value 971 is detected. The time of the internal clock, at which this peak 971p of the correlation value is detected, is stored as a frame timing (time of the rear end of the synchronization signal 915) Ts. Thereafter, the transmission timing of each radio frame (start time of each radio frame) is set based on the frame timing Ts until the next time synchronization process (frame-timing detection process) is performed. Further, a reception-power estimation value of the synchronization signal 915 is calculated from this peak 971p of the correlation value. Herein, in the calculation of the reception power from the peak of the correlation value, for example, it may be calculated by giving a predetermined offset amount.

As described above, according to the present embodiment, in the case that the HAPS base station 35 uses a plurality of linear polarization antennas for the feeder link radio communication with the radio relay apparatus (non-regenerative relay station) 10 in the upper airspace, it becomes possible to suppress fluctuations in the reception power of the specific known signal (synchronization signal) from the HAPS base station 35 due to the attitude change of the radio relay apparatus 10, and perform the appropriate gain control of the power amplifier section (power amplifier) of the radio relay apparatus 10 based on the reception power of the known signal.

Since the present invention is capable of constructing a stable high altitude platform station (HAPS) using the radio relay apparatus (non-regenerative relay station) 10 in the upper airspace, it is possible to contribute to achieving Goal 9 of the Sustainable Development Goals (SDGs), “Create a foundation for industry and technological innovation”.

It is noted that, the process steps and configuration elements of the communication system, mobile communication system, base station, base station apparatus, radio relay apparatus and terminal apparatus (user equipment, mobile station) described in the present description can be implemented with various means. For example, these process steps and configuration elements may be implemented with hardware, firmware, software, or a combination thereof.

With respect to hardware implementation, means such as processing units or the like used for establishing the foregoing steps and configuration elements in entities (for example, various kinds of radio communication apparatuses, Node B, terminal apparatus, hard disk drive apparatus, or optical disk drive apparatus) may be implemented in one or more of an application-specific IC (ASIC), a digital signal processor (DSP), a digital signal processing apparatus (DSPD), a programmable logic device (PLD), a field programmable gate array (FPGA), a processor, a controller, a microcontroller, a microprocessor, an electronic device, other electronic unit, computer, or a combination thereof, which are designed so as to perform a function described in the present specification.

With respect to the firmware and/or software implementation, means such as processing units or the like used for establishing the foregoing configuration elements may be implemented with a program (for example, code such as procedure, function, module, instruction, etc.) for performing a function described in the present specification. In general, any computer/processor readable medium of materializing the code of firmware and/or software may be used for implementation of means such as processing units and so on for establishing the foregoing steps and configuration elements described in the present specification. For example, in a control apparatus, the firmware and/or software code may be stored in a memory and executed by a computer or processor. The memory may be implemented within the computer or processor, or outside the processor. Further, the firmware and/or software code may be stored in, for example, a medium capable being read by a computer or processor, such as a random-access memory (RAM), a read-only memory (ROM), a non-volatility random-access memory (NVRAM), a programmable read-only memory (PROM), an electrically erasable PROM (EEPROM), a FLASH memory, a floppy (registered trademark) disk, a compact disk (CD), a digital versatile disk (DVD), a magnetic or optical data storage unit, or the like. The code may be executed by one or more of computers and processors, and a certain aspect of functionalities described in the present specification may by executed by a computer or processor.

The medium may be a non-transitory recording medium. Further, the code of the program may be executable by being read by a computer, a processor, or another device or an apparatus machine, and the format is not limited to a specific format. For example, the code of the program may be any of a source code, an object code, and a binary code, and may be a mixture of two or more of those codes.

The description of embodiments disclosed in the present specification is provided so that the present disclosures can be produced or used by those skilled in the art. Various modifications of the present disclosures are readily apparent to those skilled in the art and general principles defined in the present specification can be applied to other variations without departing from the spirit and scope of the present disclosures. Therefore, the present disclosures should not be limited to examples and designs described in the present specification and should be recognized to be in the broadest scope corresponding to principles and novel features disclosed in the present specification.

### REFERENCE SIGNS LIST

10: radio relay apparatus
10A(1), 10A(2): large cell (sector cell)
15: flying object
20A(1), 20A(2): terrestrial cell
30: HAPS core network
35: HAPS base station
36: externally-attached phase control apparatus
50: central control server
55: external-line transmission and reception section
60: terminal apparatus (UE)
60(1), 60(2): terminal apparatus (UE)
101: SL antenna apparatus
102: FL antenna apparatus
110: power amplifier
111: duplexer section
113: filter section
114: frequency conversion section
115: filter section
116: duplexer section
117: internal clock
119: middle-stage power amplifier
121: antenna
350: base station apparatus
351: FL antenna apparatus
352: base-station processing section (including phase control)
353: scheduler section
355: phase control apparatus

1. A communication system comprising:
a radio relay apparatus; and
a base station for wirelessly communicating with the radio relay apparatus,
wherein the base station comprises:
an antenna apparatus that has a plurality of linear polarization antennas capable of transmitting and receiving radio waves with different angles of linear polarization planes from each other when performing a feeder-link communication with the radio relay apparatus; and
a base-station processing section for controlling a phase difference between plural transmission signals supplied to the plurality of the linear polarization antennas, so that a combined polarization of radio waves of the known signal transmitted from the antenna apparatus to the radio relay apparatus becomes a circular polarization or an elliptical polarization, with respect to a predetermined time slot for transmitting to the radio relay apparatus a specific known signal usable for gain control of a power amplifier of the radio relay apparatus, and
wherein the radio relay apparatus comprises a power amplifier capable of performing a gain control so that a power of a transmission signal transmitted to a terminal apparatus is set to a predetermined power, based on a reception power of the known signal received from the base station.

2. A communication system comprising:
a radio relay apparatus; and
a base station for wirelessly communicating with the radio relay apparatus,
wherein the base station comprises:
an antenna apparatus that has a plurality of linear polarization antennas capable of transmitting and receiving radio waves with different angles of linear polarization planes from each other when performing a feeder-link communication with the radio relay apparatus; and
an externally-attached phase control apparatus for controlling a phase difference between plural transmission signals supplied to the plurality of the linear polarization antennas, so that a combined polarization of radio waves of the known signal transmitted from the antenna apparatus to the radio relay apparatus becomes a circular polarization or an elliptical polarization, with respect to a predetermined time slot for transmitting to the radio relay apparatus a specific known signal usable for gain control of a power amplifier of the radio relay apparatus, and
wherein the radio relay apparatus comprises a power amplifier capable of performing a gain control so that a power of a transmission signal transmitted to a terminal apparatus is set to a predetermined power, based on a reception power of the known signal received from the base station.

3. The communication system according to claim 1,
wherein the plurality of the linear polarization antennas are a first linear polarization antenna and a second linear polarization antenna whose linear polarization planes are orthogonal to each other, and
wherein the base-station processing section or the phase control apparatus controls, for the predetermined time slot, the phase difference between the plural transmission signals supplied to each of the first linear polarization antenna and the second linear polarization antenna, so as to be 90 degrees or −90 degrees.

4. The communication system according to claim 1,
wherein the radio relay apparatus detects a timing of the known signal received from the base station by performing a correlation process with a replica of the known signal, measures a reception power of the known signal based on the timing of the known signal, and performs a gain control of the power amplifier based on a measurement result of the reception power of the known signal.

5. The communication system according to claim 1,
wherein the base station is provided in a gateway station.

6. The communication system according to claim 1,
wherein the radio relay apparatus is mounted on a floating object or a flying object that is positioned in an upper airspace.

7. A base station for wirelessly communicating with a radio relay apparatus, comprising:
an antenna apparatus that has a plurality of linear polarization antennas capable of transmitting and receiving radio waves with different angles of linear polarization planes from each other when performing a feeder-link communication with the radio relay apparatus; and
a base-station processing section for controlling a phase difference between plural transmission signals supplied to the plurality of the linear polarization antennas, so that a combined polarization of radio waves of the known signal transmitted from the antenna apparatus to the radio relay apparatus becomes a circular polarization or an elliptical polarization, with respect to a predetermined time slot for transmitting to the radio relay apparatus a specific known signal usable for gain control of a power amplifier of the radio relay apparatus.

8. A base station for wirelessly communicating with a radio relay apparatus, comprising:
an antenna apparatus that has a plurality of linear polarization antennas capable of transmitting and receiving radio waves with different angles of linear polarization planes from each other when performing a feeder-link communication with the radio relay apparatus; and
an externally-attached phase control apparatus for controlling a phase difference between plural transmission signals supplied to the plurality of the linear polarization antennas, so that a combined polarization of radio waves of the known signal transmitted from the antenna apparatus to the radio relay apparatus becomes a circular polarization or an elliptical polarization, with respect to a predetermined time slot for transmitting to the radio relay apparatus a specific known signal usable for gain control of a power amplifier of the radio relay apparatus.

9. The base station according to claim 7,
wherein the plurality of the linear polarization antennas are a first linear polarization antenna and a second linear polarization antenna whose linear polarization planes are orthogonal to each other, and
wherein the base-station processing section or the phase control apparatus controls, for the predetermined time slot, the phase difference between the plural transmission signals supplied to each of the first linear polarization antenna and the second linear polarization antenna, so as to be 90 degrees or −90 degrees.

10. An externally-attached phase control apparatus disposed between a base station apparatus of a base station for wirelessly communicating with a radio relay apparatus and an antenna apparatus having a plurality of linear polarization antennas, the antenna apparatus being capable of transmitting and receiving radio waves with different angles of linear polarization planes from each other when performing a feeder-link communication with the radio relay apparatus, and
wherein the externally-attached phase control apparatus controls a phase difference between plural transmission signals supplied to the plurality of the linear polarization antennas, so that a combined polarization of radio waves of the known signal transmitted from the antenna apparatus to the radio relay apparatus becomes a circular polarization or an elliptical polarization, with respect to a predetermined time slot for transmitting to the radio relay apparatus a specific known signal usable for gain control of a power amplifier of the radio relay apparatus.

11. A method for wirelessly communicating between a base station and a radio relay apparatus, the method comprising:
controlling, by the base station, a phase difference between plural transmission signals supplied to the plurality of the linear polarization antennas, so that a combined polarization of radio waves of the known signal transmitted from the antenna apparatus to the radio relay apparatus becomes a circular polarization or an elliptical polarization, via an antenna apparatus that has a plurality of linear polarization antennas capable of transmitting and receiving radio waves with different angles of linear polarization planes from each other when performing a feeder-link communication with the radio relay apparatus, with respect to a predetermined time slot for transmitting to the radio relay apparatus a specific known signal usable for gain control of a power amplifier of the radio relay apparatus; and
controlling, by the radio relay apparatus, a gain of a power amplifier so that a power of a transmission signal transmitted to a terminal apparatus is set to a predetermined power, based on a reception power of the known signal received from the base station.

12. A non-transitory computer readable medium containing software that is executed by a computer or processor provided in a base station for wirelessly communicating with a radio relay apparatus, the software comprising:
executable code that controls a phase difference between plural transmission signals supplied to the plurality of the linear polarization antennas, so that a combined polarization of radio waves of the known signal transmitted from the antenna apparatus to the radio relay apparatus becomes a circular polarization or an elliptical polarization, via an antenna apparatus that has a plurality of linear polarization antennas capable of transmitting and receiving radio waves with different angles of linear polarization planes from each other when performing a feeder-link communication with the radio relay apparatus, with respect to a predetermined time slot for transmitting to the radio relay apparatus a specific known signal usable for gain control of a power amplifier of the radio relay apparatus.

13. The communication system according to claim 2,
wherein the plurality of the linear polarization antennas are a first linear polarization antenna and a second linear polarization antenna whose linear polarization planes are orthogonal to each other, and
wherein the base-station processing section or the phase control apparatus controls, for the predetermined time slot, the phase difference between the plural transmission signals supplied to each of the first linear polarization antenna and the second linear polarization antenna, so as to be 90 degrees or −90 degrees.

14. The communication system according to claim 2,
wherein the radio relay apparatus detects a timing of the known signal received from the base station by performing a correlation process with a replica of the known signal, measures a reception power of the known signal based on the timing of the known signal, and performs a gain control of the power amplifier based on a measurement result of the reception power of the known signal.

15. The communication system according to claim 13,
wherein the radio relay apparatus detects a timing of the known signal received from the base station by performing a correlation process with a replica of the known signal, measures a reception power of the known signal based on the timing of the known signal, and performs a gain control of the power amplifier based on a measurement result of the reception power of the known signal.

16. The communication system according to claim 2,
wherein the base station is provided in a gateway station.

17. The communication system according to claim 3,
wherein the base station is provided in a gateway station.

18. The communication system according to claim 2,
wherein the radio relay apparatus is mounted on a floating object or a flying object that is positioned in an upper airspace.

19. The communication system according to claim 3,
wherein the radio relay apparatus is mounted on a floating object or a flying object that is positioned in an upper airspace.

20. The base station according to claim 8,
wherein the plurality of the linear polarization antennas are a first linear polarization antenna and a second linear polarization antenna whose linear polarization planes are orthogonal to each other, and
wherein the base-station processing section or the phase control apparatus controls, for the predetermined time slot, the phase difference between the plural transmission signals supplied to each of the first linear polarization antenna and the second linear polarization antenna, so as to be 90 degrees or −90 degrees.
